(19) United States
(12) Patent Application Publication
(10) Pub. No.: US 2012/0227909 A1
(43) Pub. Date: Sep. 13, 2012

(54) Removal Roller, Device and Method for Detaching a Film from a Disc-Shaped Workpiece

(75) Inventor: Rüdiger Schindler, Neustadt-Birkig (DE)

(73) Assignee: ERS electronic GmbH, Germering (DE)

(21) Appl. No.: 13/496,171

(22) PCT Filed: Sep. 14, 2010
(86) PCT No.: PCT/EP2010/063486

§ 371 Date: May 29, 2012

(30) Foreign Application Priority Data
Sep. 15, 2009 (DE) 10 2009 041 294.8

(51) Int. Cl. B32B 38/10

(52) U.S. Cl. 156/707; 156/758; 156/752

(57) ABSTRACT

The present invention provides a removal roller (12) for detaching a film (2) from a disc-shaped workpiece (3), in particular from a mould wafer (3), comprising a film handling portion (13) for non-positively taking up or for expelling a portion (14) of the film (2). The present invention also provides a device (1) for detaching a film (2) from a disc-shaped workpiece (3), in particular from a mould wafer (3), comprising: a mounting means (4) for non-positively mounting the disc-shaped workpiece (3); a removal roller (12) of this type; a displacement means (17) for moving the removal roller (12) horizontally and/or vertically to a surface (10) of the mounting means (4); and a rotation means (24) for rotating the removal roller (12) about a centre axis (25) of the removal roller (12). Furthermore, the present invention also provides a method for detaching a film (2) from a disc-shaped workpiece (3), in particular from a mould wafer (3), by means of a device (1) of this type.

The present invention relates to a removal roller, to a device comprising a removal roller of this type and to a method using a device of this type for detaching a film from a disc-shaped workpiece, in particular from a mould wafer.

Although the present invention and the problem which it addresses can be applied to any disc-shaped workpieces, they will be described in detail with respect to a mould wafer.

The device according to the invention is arranged in particular in a wafer production line and is used to detach and separate a film from a disc-shaped workpiece, in particular from a mould wafer or a compound wafer. A mould wafer or compound wafer is a composite wafer which is produced by assembling individual chips, for example silicon chips, into a wafer-shaped structure, the chips being bonded together by a plastics material to form a disc-shaped structure. In the course of various working steps for the production of a wafer of this type, films are applied, in particular affixed or attached enduringly by an adhesive effect to disc-shaped workpieces. These films have a self-adhesive characteristic. The films are used, for example as protective and cover films during individual processing steps, but they can also be functionally significant for the processing of the workpieces, for example for fixing individual workpiece parts or as bilateral adhesive supports for the adhesive treatment and for transporting the workpiece by machine tools.

Before the mould wafer is finished, it is necessary, particularly in an assembly line-type processing method, to detach the film from the mould wafer as carefully and reliably as possible and as far as possible without any remainder, particularly at a high speed and with great dependability.

This object is achieved by a removal roller which has the features of claim 1 and/or by a device which has the features of claim 4 and/or by a method which has the features of claim 9.

According thereto, the following are provided:

A removal roller for detaching a film from a disc-shaped workpiece, in particular from a compound wafer, comprising a film handling portion for non-positively taking up or expelling a portion of the film.

A device for detaching a film from a disc-shaped workpiece, in particular from a compound wafer, comprising: a mounting means for non-positively mounting the disc-shaped workpiece; a removal roller with a film handling portion for non-positively taking up or expelling a portion of the film; a displacement means for moving the removal roller horizontally and/or vertically to a surface of the mounting means; and a rotation means for rotating the removal roller about a centre axis of the removal roller.

A method for detaching a film from a disc-shaped workpiece, in particular from a compound wafer, using a device of this type, comprising the following steps: moving the removal roller horizontally from a parking position into a take-up position of the removal roller, the film handling portion facing the film in the parking position; activating the film handling portion and vertically lowering the removal roller onto the film; affixing the portion of the film on the removal roller; vertically raising the removal roller from the disc-shaped workpiece, the portion of the film being detached at least progressively from the disc-shaped workpiece; rotating the removal roller by a predetermined wrap angle to at least progressively wind up the portion of the film onto the removal roller and simultaneously moving the removal roller horizontally in the direction of the parking position, the film being progressively detached from the disc-shaped workpiece; vertically moving the removal roller away from the disc-shaped workpiece, simultaneously with the horizontal movement, as far as a horizontal end position of the removal roller; horizontally moving the removal roller beyond the parking position into an expulsion position, the film being completely detached from the disc-shaped workpiece in the expulsion position; unwinding the portion of film, wound onto the removal roller, from the removal roller by rotating the removal roller in the opposite direction by a portion of the predetermined wrap angle such that the film handling portion is positioned in a discharge position; and expelling the film from the removal roller by the film handling portion. In this respect, the film, in particular a portion of the film adheres to the removal roller by means of the film handling portion of the removal roller. A horizontal and vertical movement of the removal roller relative to the disc-shaped workpiece automatically detaches the film rapidly from the disc-shaped workpiece without leaving any remainder.

Advantageous configurations and developments of the present invention are provided in the subclaims and in the description, combined with the figures of the drawings.

According to a preferred development of the removal roller, the film handling portion is configured as a switchable vacuum/excess pressure portion, in particular as a suction/blowing nozzle or as a suction/blowing slot arranged along a centre axis of the removal roller, for non-positively taking up the portion of the film by a vacuum or for expelling the portion of the film by means of an excess pressure. This ensures a reliable take-up and expulsion action of the portion of film.

According to a further preferred development of the removal roller, said roller has an adhesion sensor, in particular a vacuum switch for establishing the non-positive take-up or expulsion of the portion of film by the film handling portion. Consequently, the operation of the film handling portion is monitored, thus enhancing the operational reliability of the removal roller.

According to a preferred development of the device, the displacement means comprises a horizontal displacement element for moving the removal roller horizontally to the surface of the mounting means and a vertical displacement element for moving the removal roller vertically to the surface of the mounting means. This allows the removal roller to be positioned rapidly and precisely relative to the disc-shaped workpiece.

According to a further preferred development of the device, said device comprises a heating means for heating the disc-shaped workpiece and/or the film to a predetermined temperature, in particular to a temperature between 180° C. and 240° C., thus ensuring a reliable detachment of the film from the disc-shaped workpiece.

According to a further preferred development of the device, the mounting means comprises a drive element for rotating a workpiece mount of the mounting means about an axis of rotation of the workpiece mount. This makes it possible for the workpiece mount to be rotated before the film is removed, as a result of which a detachment angle of the film from the disc-shaped workpiece can advantageously be adjusted. This facilitates the removal of the film from the disc-shaped workpiece.

According to a further preferred development of the device, said device comprises a blowing means for blowing a portion of the film projecting over the disc-shaped workpiece, said blowing means being configured such that it blows the projecting portion in the direction of the removal roller. This ensures a reliable take-up of the portion by the removal roller, thereby enhancing the reliability of the device.

According to a preferred development of the method, the rotational movement, the vertical movement and the horizontal movement of the removal roller merge into one another such that the film is detached smoothly from the disc-shaped workpiece. This reliably prevents remnants of the film from remaining on the disc-shaped workpiece or the disc-shaped workpiece will be damaged.

According to a further preferred development of the method, the film is removed from the disc-shaped workpiece at a predetermined temperature, in particular at a temperature of 180° C. to 240° C. This ensures a simple and complete detachment of the film from the disc-shaped workpiece.

According to a further preferred development of the method, a portion of the film, projecting over the disc-shaped workpiece is blown in the direction of the removal roller by a blowing means for affixing the portion of the film to the removal roller. This provides a straightforward take-up of the portion of film by the removal roller, thereby enhancing the reliability of the method.

According to a further preferred development of the method, an angle of 180° is selected as the wrap angle. This reliably ensures that the portion of film slips off the removal roller.

According to a further preferred development of the method, the workpiece mount of the mounting means is rotated by a removal angle before the film is removed. Consequently, a detachment angle of the film from the disc-shaped workpiece can advantageously be adjusted, thereby facilitating and accelerating the detachment of the film from the disc-shaped workpiece.

According to a further preferred development of the method, the expulsion of the film from the removal roller into a film disposal means is monitored by an expulsion sensor, in particular by a light grid, of the film disposal means. Consequently, it is possible to reliably detect a film which has not been detached from the removal roller, as a result of which the malfunction susceptibility of the method is reduced.

In the following, the invention will be described in more detail on the basis of embodiments with reference to the accompanying figures of the drawings, in which:

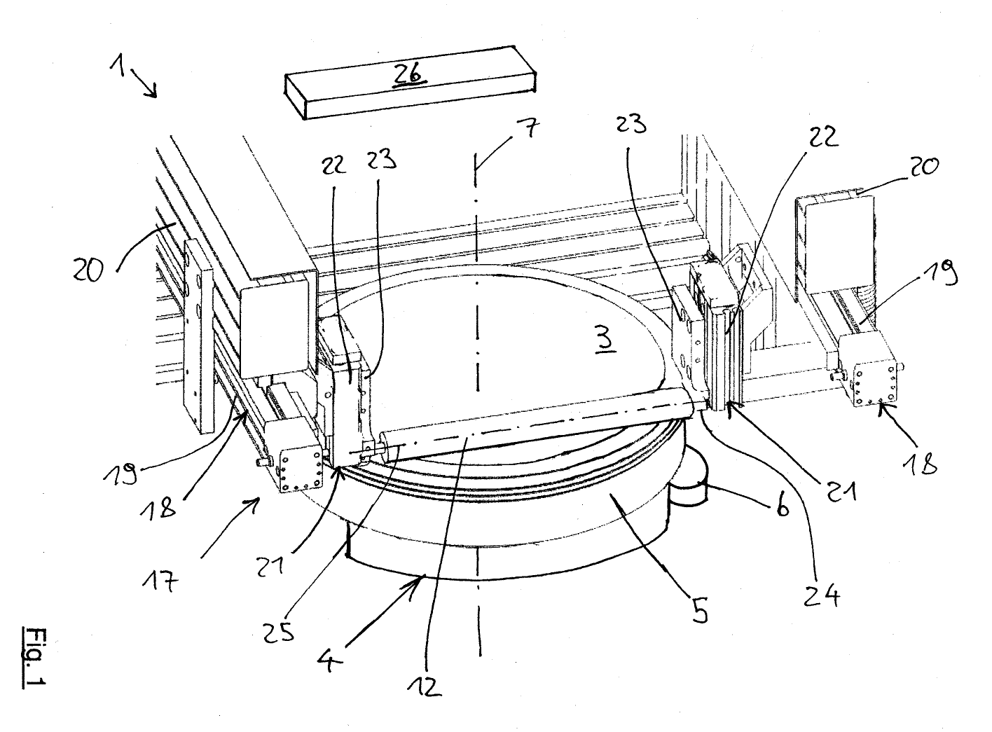

FIG. 1 is a perspective view of a device according to a preferred embodiment of the present invention;

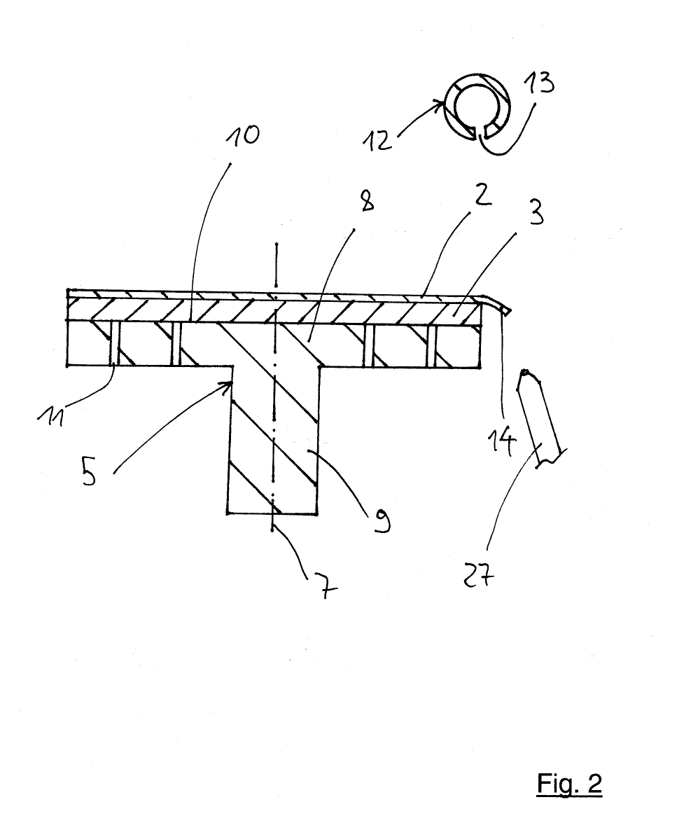

FIG. 2 is a sectional view of the device according to FIG. 1;

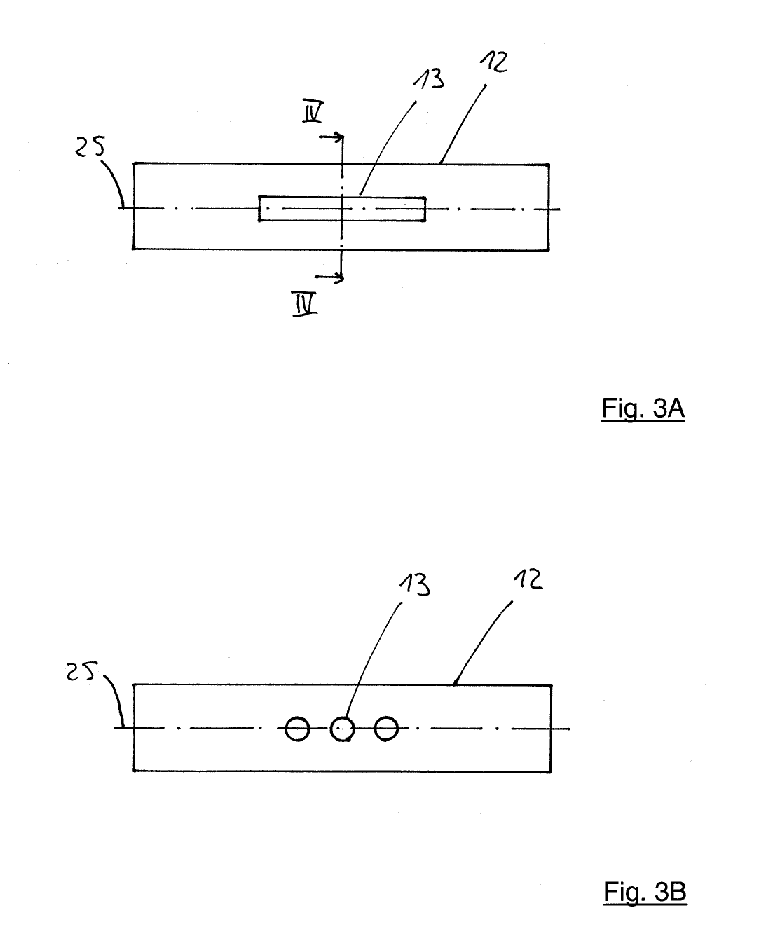

FIG. 3A is a plan view of a removal roller according to a preferred embodiment of the present invention;

FIG. 3B is a plan view of a removal roller according to a further preferred embodiment of the present invention;

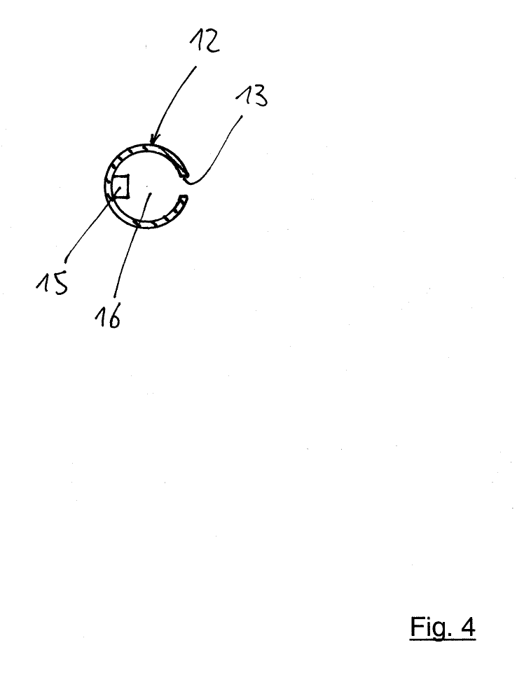

FIG. 4 is a sectional view of the removal roller along line IV-IV according to FIG. 3A;

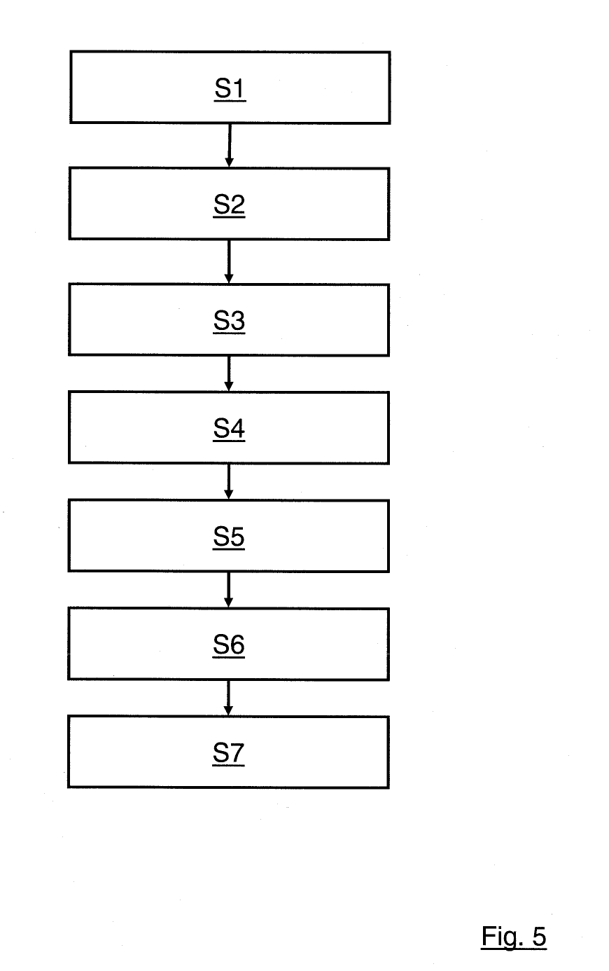

FIG. 5 is a flow chart illustration of a method according to a preferred embodiment of the present invention;

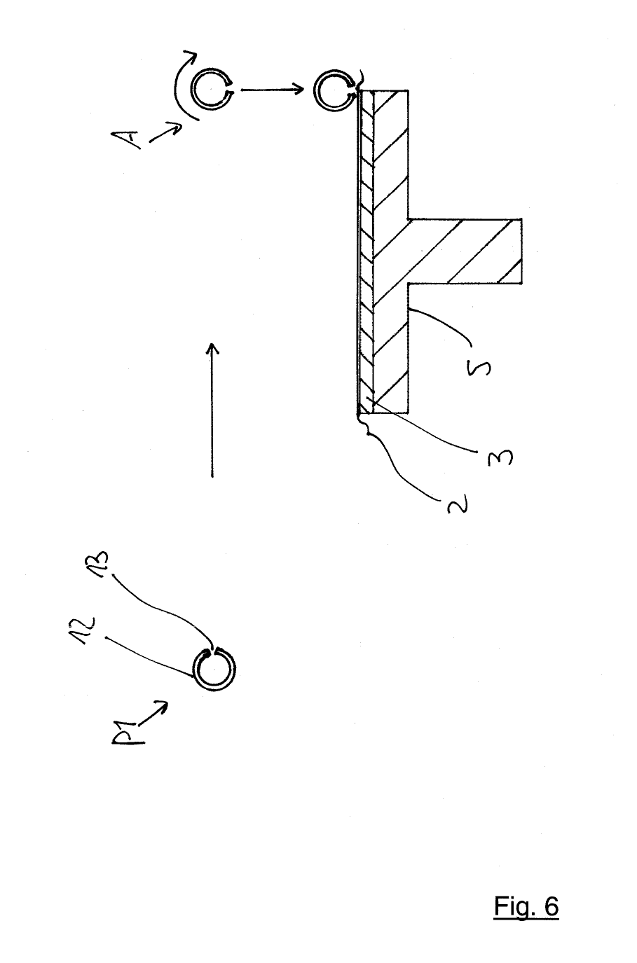

FIG. 6 is a sectional view of the device according to FIG. 1 during implementation of a step of the method according to FIG. 5;

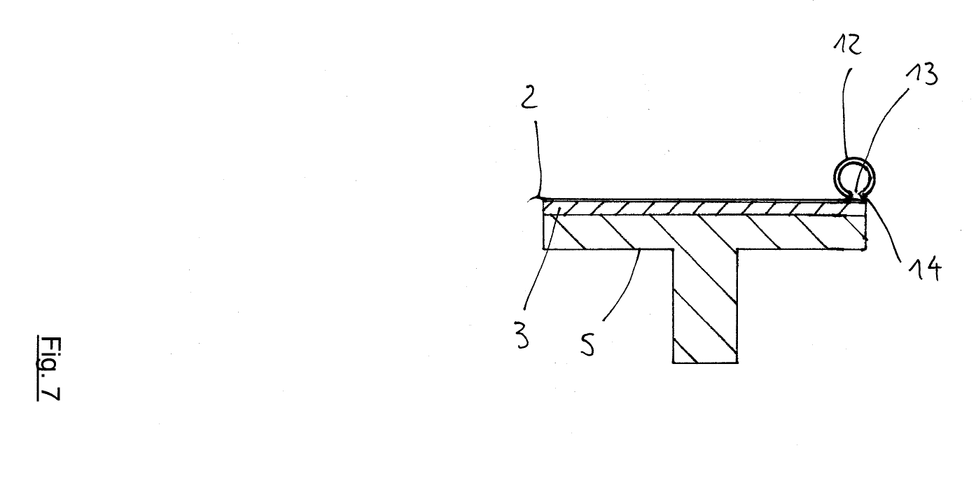

FIG. 7 is a sectional view of the device according to FIG. 1 during implementation of a further step of the method according to FIG. 5;

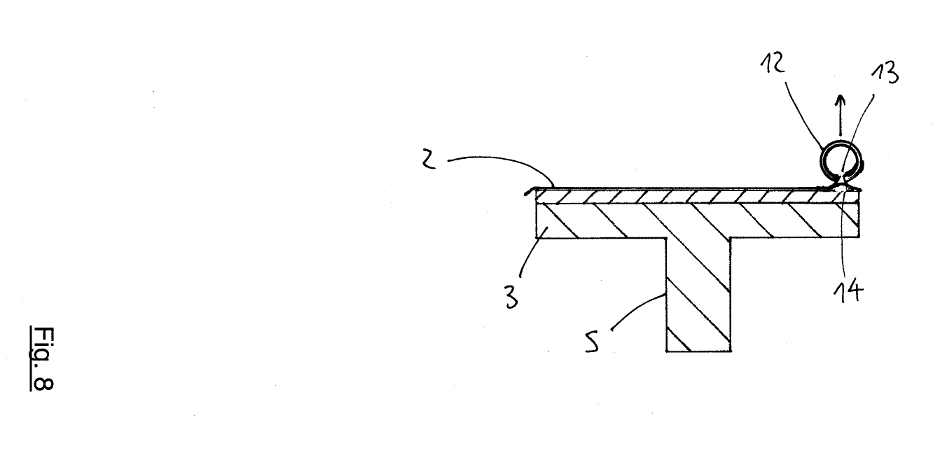

FIG. 8 is a sectional view of the device according to FIG. 1 during implementation of a further step of the method according to FIG. 5;

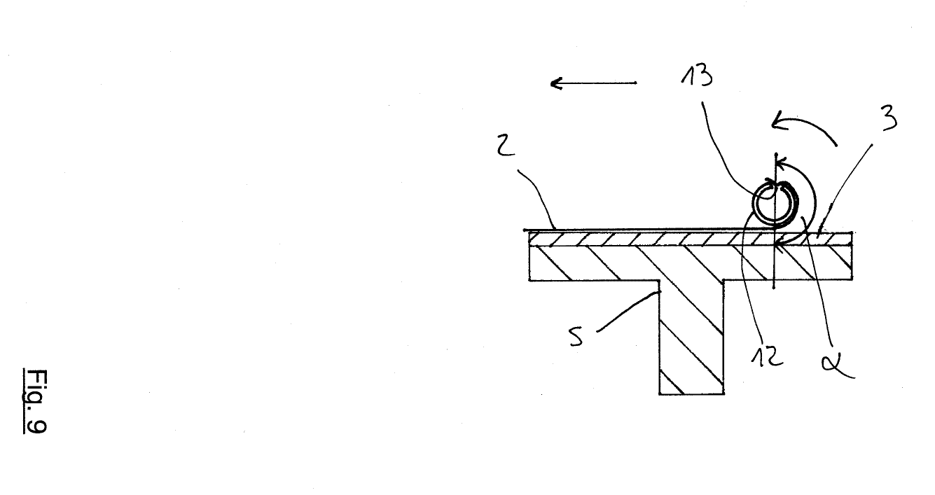

FIG. 9 is a sectional view of the device according to FIG. 1 during implementation of a further step of the method according to FIG. 5;

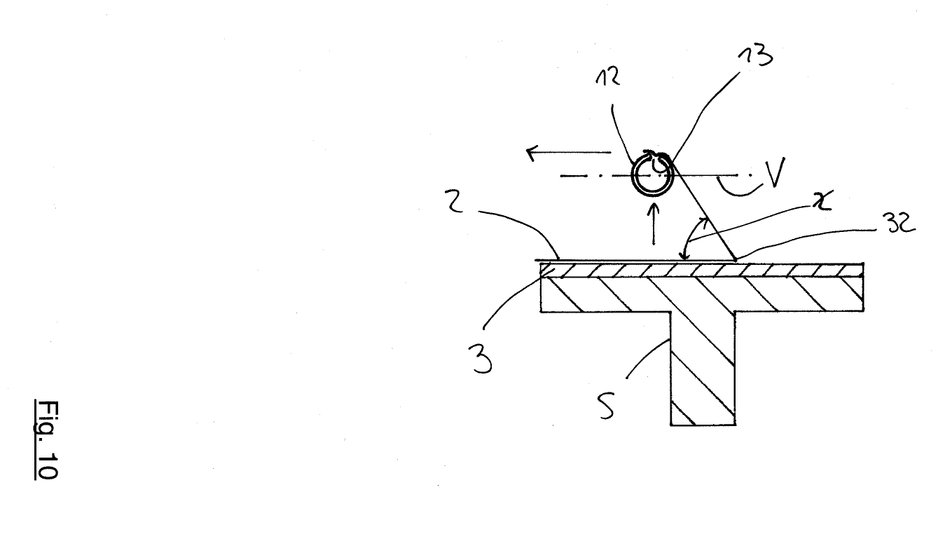

FIG. 10 is a sectional view of the device according to FIG. 1 during implementation of a further step of the method according to FIG. 5;

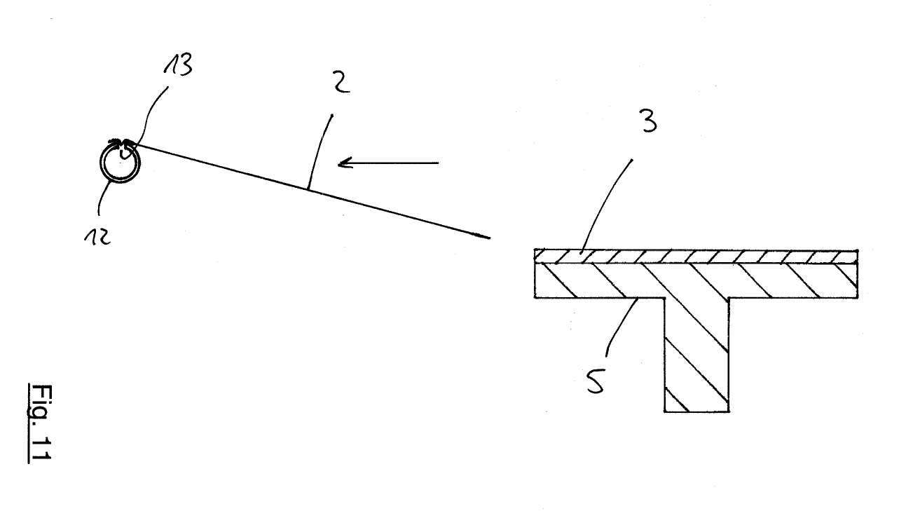

FIG. 11 is a sectional view of the device according to FIG. 1 during implementation of a further step of the method according to FIG. 5;

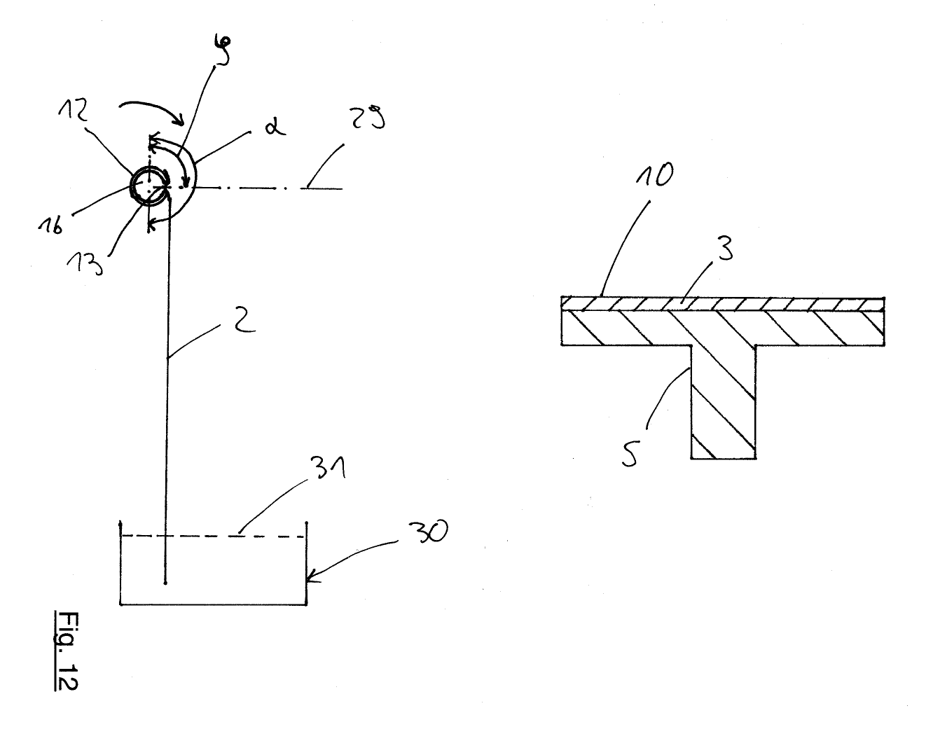

FIG. 12 is a sectional view of the device according to FIG. 1 during implementation of a further step of the method according to FIG. 5; and

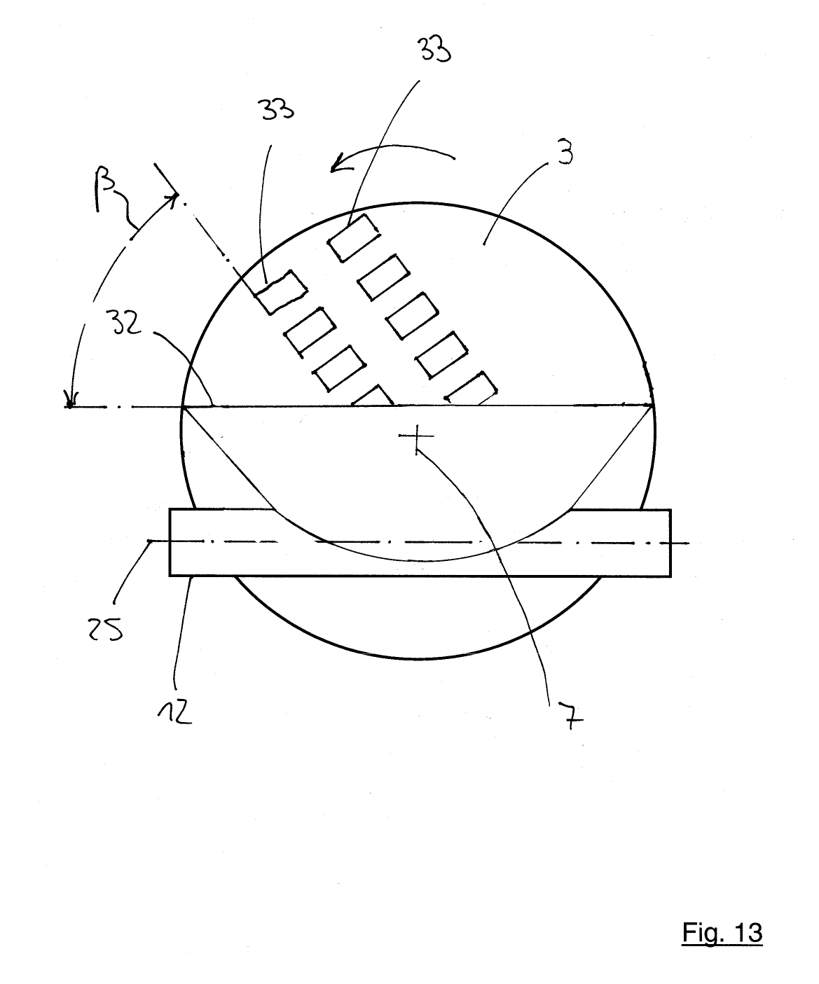

FIG. 13 is a plan view of the device according to FIG. 1 during implementation of a further step of the method according to FIG. 5.

In the figures, the same reference signs denote the same or functionally identical components, unless indicated otherwise.

FIG. 1 is a perspective view of a device 1 for removing or detaching a film 2 from a disc-shaped workpiece 3, in particular from a compound wafer 3 or a mould wafer 3. FIG. 2 is a sectional view of the device 1 according to FIG. 1. FIG. 3 is a plan view of a removal roller 12 and FIG. 4 is a sectional view of a removal roller 12 of the device 1. In the following, reference will be made simultaneously to FIGS. 1 to 4. The device 1 preferably comprises a mounting means 4 for non-positively mounting the disc-shaped workpiece 3 on a surface 10 of the mounting means 4. The mounting means 4 preferably comprises a workpiece mount 5 which can be rotated about an axis of rotation 7 of the workpiece mount 5, for example by a drive element 6. The workpiece mount 5 substantially comprises a plate-shaped workpiece supporting portion 8 and a cylindrical shank portion 9 extending out of the workpiece supporting portion 8. The workpiece supporting portion 8 has a surface 10 on which the disc-shaped workpiece 3 is arranged. The disc-shaped workpiece 3 is fixed in a non-positive manner on the mounting means 4, for example by a vacuum. For this purpose, the workpiece supporting portion 8 has, for example, a plurality of vacuum holes 11, only one of which has been provided with a reference numeral, by which the disc-shaped workpiece 3 is drawn by suction onto the surface 10 of the mounting means 4. The vacuum holes 11 are preferably actively connected to a vacuum means (not shown) of the device 1. The shank portion 9 preferably extends out of a surface, remote from the surface 10, of the workpiece supporting portion 8.

The device 1 also comprises a removal roller 12 which is configured, for example in the form of a hollow cylinder with a centre axis 25. The removal roller 12 preferably has a film handling portion 13 which is configured to non-positively take up or expel the film 2, in particular a portion 14 of the film 2. The portion 14 of the film 2 is, for example, an end portion 14 or a peripheral portion 14 of the film 2. The portion 14 of the film 2 can, for example, project laterally over the disc-shaped workpiece 3 and/or over the workpiece mount 5. The film handling portion 13 is preferably configured as a switchable vacuum-excess pressure portion 13. Alternatively, the film handling portion 13 can be configured as a clamping means with a clamping gripper for gripping the film 2. For example, as illustrated in FIG. 3A, the film handling portion 13 is configured as a suction/blowing slot 13 arranged along the centre axis 25 of the removal roller 12. As an alternative or in addition, the film handling portion 13 according to FIG. 3B can be configured as a suction/blowing nozzle 13 or as a plurality of suction/blowing nozzles 13. The film handling portion 13 is either configured for non-positively taking up the film 2, in particular the portion 14 of the film 2, by a vacuum or is configured for expelling the film 2, in particular the portion 14, from the removal roller 12 by an excess pressure. For this purpose, the device 1 comprises, for example, a vacuum/excess pressure means (not shown). Thus, the film handling portion 13 selectively provides both a non-positive take-up of the film 2, in particular of the portion 14 of the film 2, as well as an expulsion of the film 2, in particular of the portion 14 of the film 2, from the removal roller 12. Furthermore, the removal roller 12 preferably comprises an adhesion sensor 15 which is configured, for example, as a vacuum switch 15. The adhesion sensor 15 is arranged, for example, in the interior 16 of the removal roller 12. The purpose of the adhesion sensor 15 is to establish the non-positive take-up or expulsion of the film 2, in particular of the portion 14 of the film 2, by the film handling portion 13.

Furthermore, the device 1 preferably comprises a displacement means 17 for moving the removal roller 12 horizontally and/or vertically to the surface 10 of the mounting means 4. The displacement means 17 preferably comprises a horizontal displacement element 18 for moving the removal roller 12 horizontally to the surface 10 of the mounting means 4. The horizontal displacement element 18 preferably has a guide profile 19 which can be moved linearly, for example relative to a fixed frame profile 20 of the device 1. A linear movement of the profiles 19, 20 relative to one another is realised, for example by an electric motor. The device 1 preferably comprises two horizontal displacement elements 18 which are each positioned bilaterally on end portions of the removal roller 12. The displacement means 17 preferably also comprises a vertical displacement element 21 for moving the removal roller 12 vertically to the surface 10 of the mounting means 4. The vertical displacement element 21 comprises, for example, a sliding body 23 which can be displaced linearly along a guide profile 22. The sliding body 23 can be moved relative to the guide profile 22, for example by an electric motor. The guide profile 22 is mounted, for example, on the guide profile 19 of the horizontal displacement element 17. The device 1 preferably comprises two vertical displacement elements 21 which are each arranged on the end portions of the removal roller 12. The removal roller 12 is preferably mounted in the sliding body 23 of the vertical displacement element 21 such that it can rotate about its centre axis 25.

Furthermore, the device 1 preferably comprises a rotation means 24 for rotating the removal roller 12 about its centre axis 25. The rotation means 24 comprises, for example, an electric motor coupled with the removal roller 12. The electric motor can be actively connected to the removal roller 12, for example directly or by a reduction stage, for example by a belt drive.

The device preferably also comprises a heating means 26 for heating the disc-shaped workpiece 3 and/or the film 2 to a predetermined temperature. The film 2 is provided, for example, with a heat-sensitive adhesive layer and is affixed by this layer to the disc-shaped workpiece 3. The heating means 26 is configured, for example, as an infrared radiator 26 or as a hot air fan 26. The heating means 26 can be, for example, an integral component of the mounting means 4, for example the heating means 26 can be configured as a heating loop integrated into the workpiece support 8. Alternatively, the heating means 26 can be arranged at a distance from the mounting means 4. The heating means 26 is preferably used for heating the disc-shaped workpiece and/or the film to a temperature between 180° and 240° C.

The device 1 preferably also comprises a blowing means 27 for blowing a portion 14 of the film 2 which projects over the disc-shaped workpiece 3. The blowing means 27 is configured, for example, as an air nozzle 27 or as a plurality of air nozzles 27. The blowing means 27 deforms the portion 14 of the film 2 which projects over the disc-shaped workpiece 3 such that said portion is curved in the direction of the removal roller 12. The blowing means 27 can be integrated into the mounting means 4, for example.

FIGS. 5 to 13, to which reference will be made simultaneously in the following, illustrate a method for detaching the film 2 from the disc-shaped workpiece 3 using a device 1 of the type according to FIGS. 1 to 4. In a step S1 shown in FIG. 6, the removal roller 12 is moved horizontally by the displacement means 17, in particular by the horizontal displacement element 18 of the displacement means 17, from a parking position P1 of the removal roller 12 into a take-up position A of the removal roller 12. In the take-up position A, the film handling portion 13 faces the film 2 by means of the rotation means 24. Step S1 preferably also includes an activation of the film handling portion 13, for example the connection of a vacuum and a vertical lowering of the removal roller 12 onto the film 2 by the displacement means 17, in particular by the vertical displacement element 21 of the displacement means 17. The take-up position can be adjusted, for example by a software adjustment of a control means of the device 1.

In a step S2 according to FIG. 7, the film 2, in particular the portion 14 of the film 2 is drawn by suction onto the removal roller 12 by the film handling portion 13. The portion 14 of the film 2 then adheres to the removal roller 12. Step S2 can include a blowing of the portion 14 of the film 2 by the blowing means 27 if the portion 14 projects over the disc-shaped workpiece 3. During the blowing procedure, the portion 14 is blown in the direction of the removal roller 12 such that it adheres thereto. This facilitates the take-up of the portion 14 by the film handling portion 13. The suctioning of the film 2 onto the removal roller 2 is monitored by the adhesion sensor 15.

In a step S3 which is illustrated in FIG. 8, the removal roller 12 is raised vertically from the disc-shaped workpiece 3 by the displacement means 17, in particular by the vertical displacement element 21 of the displacement means 17, the portion 14 of the film 2 being separated at least progressively from the disc-shaped workpiece 3. The film 2 and/or the disc-shaped workpiece 3 have preferably been previously heated to a predetermined temperature by the heating means 26 to detach the film 2. The removal roller 12 is initially raised from the disc-shaped workpiece 3 just until there is no longer any contact between the removal roller 12 and the disc-shaped workpiece 3.

In a step S4, illustrated in FIG. 9, the removal roller 12 is rotated by a predetermined wrap angle α by the rotation means 24 and at the same time is moved horizontally by the displacement means 17 in the direction of the parking position P1. In so doing, the film 2 is wound progressively onto the removal roller 12. The wrap angle α is preferably 180°, i.e. the film handling portion 13 is remote from the disc-shaped workpiece 3 after rotation. At the same time as the rotation of the removal roller 12, said roller is moved horizontally in the direction of the parking position P1 by the displacement means 17, in particular by the horizontal displacement element 18. In so doing, the film 2 is progressively separated from the disc-shaped workpiece 3. The rotation of the removal roller 12 and the simultaneous horizontal movement take place in a predetermined ratio. The wrap angle α or a wrap radius of the film 2 on the removal roller 12 can be adjusted, for example by a software adjustment on a control means of the device 1. Step S4 can include an intermediate step in which, after the removal roller 12 has been rotated by the wrap angle α, it is moved further horizontally and is raised vertically from the disc-shaped workpiece 3 by a safety distance during its horizontal linear movement in the direction of the parking position P1 to prevent a collision with the disc-shaped workpiece 3.

In a step S5, illustrated in FIG. 10, the removal roller 12 is moved further away vertically from the disc-shaped workpiece 3 by the displacement means 17 and at the same time is moved further horizontally until the removal roller 12 has reached a vertical end position V. The vertical end position V can correspond to a vertical position of the parking position P1. Upon reaching the vertical end position V, the removal roller 12 is moved further horizontally in the direction of the parking position P1 with the film 2 being further detached from the disc-shaped workpiece 3 at a detachment angle χ. The detachment angle χ is determined between the surface 10 of the mounting means 4 and the film 2 which is being detached.

In a step S6, illustrated in FIG. 11, the removal roller 12 is moved by the displacement means 17, in particular by the horizontal displacement element 18 of the displacement means 17, beyond the parking position P1 of the removal roller 12 into an expulsion position P2 or into the rearmost parking position P2. Upon reaching the expulsion position P2, the film 2 has preferably been completely separated from the disc-shaped workpiece 3. All the horizontal, vertical and radial movements of the removal roller 12 preferably merge into one another during the removal procedure of the film 2 from the disc-shaped workpiece 3 such that a uniform removal behaviour of the film 2 from the disc-shaped workpiece 3 is ensured and the film 2 is removed smoothly therefrom. When the film 2 is being detached from the disc-shaped workpiece 3, the removal roller 12 preferably follows a predefined trajectory. The trajectory is travelled for example by a mechanical guidance, in particular by a connecting link guide or by a suitable control means of electric motors of the displacement means 17. Horizontal, vertical and radial movement speeds of the removal roller 12 are preferably adapted to one another such that a gentle and smooth removal of the film 2 from the disc-shaped workpiece 3 is always ensured.

In a step S7, illustrated in FIG. 12, the portion 14 of the film 2 wound onto the removal roller 12 is unwound again from the removal roller 12 by a rotation of the removal roller 12 in the opposite direction by the rotation means 24. In so doing, the removal roller 12 is rotated by a portion φ of the predetermined wrap angle α such that the film handling portion 13 is positioned in a discharge position. In the discharge position of the film handling portion 13, a centre axis 29 of the film handling portion 13 is preferably aligned parallel to the surface 10 of the mounting means 4. The vacuum prevailing in the interior 16 of the removal roller 12 is disconnected and an excess pressure for example is built up in the interior 16 of the removal roller 12 such that a pressure surge blows the portion 14 of the film 2 out of the film handling portion 13. The correct expulsion of the film 2 from the removal roller 12 is monitored by the adhesion sensor 15. The film 2 is preferably placed in a waste container of a film disposal means 30, the correct placing being monitored by an expulsion sensor 31 of the film disposal means 30. The expulsion sensor 31 is preferably configured as a light grid 31. After the film 2 has been removed from the removal roller 12, said roller can be returned into its parking position P1.

If in step S2, the film 2 is not taken up by the removal roller 2 or is unintentionally detached from the removal roller 12 in one of the subsequent steps of the method, this malfunction will be detected by the adhesion sensor 15 and the device emits a trouble signal, for example. A machine operator can then remove the film 2 manually, for example, and can acknowledge the fault procedure.

According to FIG. 13, before the film 2 is removed from the disc-shaped workpiece 3, a removal angle β between a detachment edge 32 of the film 2 being detached from the disc-shaped workpiece 3 and the disc-shaped workpiece 3 can be adjusted by rotating the workpiece mount 5 of the mounting means 4 about the axis of rotation 7 thereof. As a result, the film 2 is not removed in a straight manner but obliquely from the chip paths 33 of the disc-shaped workpiece 3. Consequently, the removal roller 12 no longer travels orthogonally to the chip paths 33, but obliquely. A jerking action during removal of the film 2 is prevented. The workpiece mount 5 can be rotated for example before the film 2 is taken up.

Although the device 1 and the method for removing the film 2 have been described with the heating means 26, said heating means 26 is merely an optional component of the device 1 and/or of the method. It is possible to dispense with the heating means 26. The optional use of the heating means 26 depends, for example, on the type of adhesive layer which is used between the film 2 and the disc-shaped workpiece 3.

### LIST OF REFERENCE NUMERALS

1 device
2 film
3 disc-shaped workpiece
4 mounting means
5 workpiece mount
6 drive element
7 axis of rotation
8 workpiece supporting portion
9 shank portion
10 surface
11 vacuum hole
12 removal roller
13 film handling portion
14 portion
15 adhesion sensor
16 interior
17 displacement means
18 horizontal displacement element
19 guide profile
20 frame profile
21 vertical displacement element
22 guide profile
23 sliding body
24 rotation means
25 centre axis
26 heating means
27 blowing means
28 centre axis
30 film disposal means
31 expulsion sensor
32 detachment edge
33 chip path
A take-up position
P1 parking position
P2 expulsion position
V vertical end position
α wrap angle
β removal angle
χ detachment angle
φ angle portion

1. Removal roller (12) for detaching a film (2) from a disc-shaped workpiece (3), in particular from a mould wafer (3), comprising a film handling portion (13) for non-positively taking up or for expelling a portion (14) of the film (2).

2. Removal roller according to claim 1, characterised in that the film handling portion (13) is configured as a switchable vacuum/excess pressure portion (13), in particular as a suction/blowing nozzle (13) or as a suction/blowing slot (13) arranged along a centre axis (25) of the removal roller (12) for non-positively taking up the portion (14) of the film (2) by means of a vacuum or for expelling the portion (14) of the film (2) by means of an excess pressure.

3. Removal roller according to either claim 1 or claim 2, characterised in that the removal roller (12) has an adhesion sensor (15), in particular a vacuum switch (15) to establish the non-positive take-up or expelling of the portion (14) of the film (2) by the film handling portion (13).

4. Device (1) for detaching a film (2) from a disc-shaped workpiece (3), in particular from a mould wafer (3), comprising:
a mounting means (4) for non-positively mounting the disc-shaped workpiece (3);
a removal roller (12) with a film handling portion (13) for non-positively taking up or for expelling a portion (14) of the film (2);
a displacement means (17) for moving the removal roller (12) horizontally and/or vertically to a surface (10) of the mounting means (4); and
a rotation means (24) for rotating the removal roller (12) about a centre axis (25) of the removal roller (12).

5. Device according to claim 4, characterised in that the displacement means (17) comprises a horizontal displacement element (18) for moving the removal roller (12) horizontally to the surface (10) of the mounting means (4) and a vertical displacement element (21) for moving the removal roller (12) vertically to the surface (10) of the mounting means (4).

6. Device according to either claim 4 or claim 5, characterised in that the device (1) comprises a heating means (26) for heating the disc-shaped workpiece (3) and/or the film (2) to a predetermined temperature, in particular to a temperature between 180° C. and 240° C.

7. Device according to any one of claims 4 to 6, characterised in that the mounting means (4) comprises a drive element (6) for rotating a workpiece mount (5) of the mounting means (4) about an axis of rotation (7) of the workpiece mount (5).

8. Device according to any one of claims 4 to 7, characterised in that the device (1) comprises a blowing means (27) for blowing a portion (14) of the film (2) projecting over the disc-shaped workpiece (3), the blowing means (27) being configured such that it blows the projecting portion (14) in the direction of the removal roller (12).

9. Method for detaching a film (2) from a disc-shaped workpiece (3), in particular from a mould wafer (3), by means of a device (1) according to any one of claims 4 to 8, comprising the following steps:
moving the removal roller (12) horizontally from a parking position (P1) into a take-up position (A) of the removal roller (12), the film handling portion (13) facing the film (2) in the take-up position (A);
activating the film handling portion (13) and vertically lowering the removal roller (12) onto the film (2);
affixing the portion (14) of the film (2) to the removal roller (12);
vertically raising the removal roller (12) from the disc-shaped workpiece (3), the portion (14) of the film (2) being detached at least progressively from the disc-shaped workpiece (3);
rotating the removal roller (12) by a predetermined wrap angle (α) to at least progressively wind up the portion (14) of the film (2) on the removal roller (12) and simultaneously moving the removal roller (12) horizontally in the direction of the parking position (P1), the film (2) being progressively detached from the disc-shaped workpiece (3);
vertically moving the removal roller (12) away from the disc-shaped workpiece (3), simultaneously with the horizontal movement, as far as a horizontal end position (V) of the removal roller (12);
horizontally moving the removal roller (12) beyond the parking position (P1) into an expulsion position (P2), the film (2) being completely detached from the disc-shaped workpiece (3) in said expulsion position (P2);
unwinding the portion (14) of the film (2), wound onto the removal roller (12), from the removal roller (12) by rotating the removal roller (12) in the opposite direction by a portion (φ) of the predetermined wrap angle (α) such that the film handling portion (13) is positioned in a discharge position; and
expelling the film (2) from the removal roller (12) by the film handling portion (13).

10. Method according to claim 9, characterised in that the rotational movement, the vertical movement and the horizontal movement of the removal roller (12) merge into one another such that the film (2) is detached smoothly from the disc-shaped workpiece (3).

11. Method according to either claim 9 or claim 10, characterised in that the film (2) is detached from the disc-shaped workpiece (3) at a predetermined temperature, in particular at a temperature of 180° C. to 240° C.

12. Method according to any one of claims 9 to 11, characterised in that a portion (14) of the film (2) which projects over the disc-shaped workpiece (3) is blown in the direction of the removal roller (12) by a blowing means (27) for affixing the portion (14) of the film (2) to the removal roller (12).

13. Method according to any one of claims 9 to 12, characterised in that an angle of 180° is selected as the wrap angle (α).

14. Method according to any one of claims 9 to 13, characterised in that the workpiece mount (5) of the mounting means (4) is rotated by a removal angle (β) before the film (2) is removed.

15. Method according to any one of claims 9 to 14, characterised in that the expulsion of the film (2) from the removal roller (12) into a film disposal means (30) is monitored by an expulsion sensor (31), in particular by a light grid (31), of the film disposal means (30).
